(19) United States
(12) Patent Application Publication
(10) Pub. No.: US 2026/0087304 A1
(43) Pub. Date: Mar. 26, 2026

(54) Neural Networks with Semantic Inference

(71) Applicants: Northeastern University, Boston, MA (US); Government of the United States as represented by the Secretary of the Air Force, Rome, NY (US)

(72) Inventors: Francesco Restuccia, Boston, MA (US); Jonathan Ashdown, Arlington, VA (US); A Q M Sazzad Sayyed, Portland, ME (US)

(21) Appl. No.: 18/893,610

(22) Filed: Sep. 23, 2024

Related U.S. Application Data
(60) Provisional application No. 63/584,786, filed on Sep. 22, 2023.

(51) Int. Cl. G06N 3/042; G06F 18/2415

(52) U.S. Cl. CPC G06N 3/042; G06F 18/2415

(57) ABSTRACT

Systems and method of classification are provided. Upon receiving an input, a feature set is defined from the input. A semantic cluster to be associated with the input is defined based on the feature set, the semantic cluster being one of a plurality of semantic clusters each defining a subset of outputs of a neural network based on semantic similarity of the subset. The feature set is applied to a subgraph corresponding to the semantic cluster, the subgraph being one of a plurality of subgraphs each defining a portion of the neural network. A classification for the input is then be determined based on an output of the subgraph.

### RELATED APPLICATION

This application claims the benefit of U.S. Provisional Application No. 63/584,786, filed on Sep. 22, 2023, the entire teachings of which are incorporated herein by reference.

### GOVERNMENT SUPPORT

This invention was made with government support under FA9550-23-1-0261 from the Air Force Research Laboratories. The government has certain rights in the invention.

### BACKGROUND

Deep neural networks (DNNs) are a class of machine learning models inspired by the structure and function of the human brain. They consist of multiple layers of interconnected nodes, known as neurons, that process and transmit information. Each layer in a DNN applies mathematical transformations to the input data, gradually refining and learning complex patterns as it progresses through the network. The depth of the network, defined by the number of layers, allows it to capture increasingly abstract and sophisticated features, making DNNs particularly effective for tasks such as image recognition, natural language processing, and autonomous decision-making.

The learning process in DNNs is driven by a technique called backpropagation, which adjusts the weights of the connections between neurons based on the error between the predicted output and the actual outcome. Through multiple iterations of training on large datasets, DNNs are able to improve their performance over time. This has made them essential in a variety of fields, from computer vision and speech recognition to autonomous systems and financial modeling. As computational power and data availability have increased, DNNs have become more prevalent in tackling increasingly complex real-world problems.

### SUMMARY

Deep Neural Networks (DNNS) often incur a significant computational and data labeling burden. For ubiquitous application of DNNs, they need to be lightweight for deployment in mobile devices and devices with resource constraints (e.g., energy, bandwidth etc.). Previous approaches for such constraints include pruning, quantization, coding techniques, and dynamic neural network approaches. However, these methods can incur a drastic performance loss in accuracy.

Disclosed herein are embodiments that leverage intrinsic redundancy in representations of DNNs to drastically reduce the computational load with very limited loss in performance. In such embodiments, data is represented in different stages in DNNs by the outputs of different filters. Each filter shows a different level of activation strength for specific pattern for which it is trained. Semantically similar inputs (e.g., “otter” and “seal,” “dog” and “cat,”) share a significant number of filter activations, especially in the earlier layers of the DNN. As such, semantically similar classes can be “clustered” so as to use part of the DNN that is activated for this cluster, which is referred to as a cluster-specific subgraph. These subgraphs may be “turned on” when an input belonging to a semantic cluster is being presented to the DNN, while the rest of the DNN can be “turned off.” To this end, embodiments provide a new framework called Semantic Inference (SINF). SINF (i) identifies the semantic cluster to which the object belongs using a small additional classifier; and then (ii) executes the cluster specific subgraph extracted from the base DNN related to that semantic cluster to perform the inference. To extract each cluster-specific subgraph, embodiments disclosed herein employ a new approach, named a Discriminative Capability Score (DCS), that effectively finds the subgraph with the capability to discriminate among the members of a specific semantic cluster.

Example embodiments include a method of classification of inputs. Upon receiving an input, a feature set may be defined from the input. A semantic cluster to be associated with the input may be defined based on the feature set, the semantic cluster being one of a plurality of semantic clusters each defining a subset of outputs of a neural network based on semantic similarity of the subset. The feature set may be applied to a subgraph corresponding to the semantic cluster, the subgraph being one of a plurality of subgraphs each defining a portion of the neural network. A classification for the input may then be determined based on an output of the subgraph. “Classification,” as used herein, refers to classification of inputs as well as inference as applied to decision-making in control algorithms.

Nodes of the subgraph may correspond to a subset of filters of the neural network, the subset of filters having an activation rate that exceeds a threshold value for members of the semantic cluster. The subgraph may include at least one node common to another one of the plurality of subgraphs. The semantic cluster may be identified via at least one layer of the neural network. The subgraph may encompass a set of filters of the neural network that are excluded by at least one of the plurality of subgraphs. A subset of the subgraphs may be stored to a memory device independent of a remainder of the subgraphs.

Further embodiments include a system for classification. A feature extractor may be configured to define a feature set from an input. A predictor may be configured to identify a semantic cluster to be associated with the input based on the feature set, the semantic cluster being one of a plurality of semantic clusters each defining a subset of outputs of a neural network based on semantic similarity of the subset. A plurality of subgraphs may each define a portion of the neural network. A router may be configured to apply the feature set to a subgraph corresponding to the semantic cluster, the subgraph being one of a plurality of the plurality of subgraphs. The subgraph may be configured to generate an output for determining a classification for the input.

Further embodiments include a method of optimizing a neural network. A plurality of semantic clusters may be defined for a dataset of inputs to the neural network, each of the semantic clusters including a subset of the inputs based on semantic similarity of the subset. A plurality of subgraphs each corresponding to one of the semantic clusters may be defined, each of the subgraphs being a portion of the neural network. A router may be generated to associate an input with one of the semantic clusters, and to apply the input to the associated semantic cluster.

### BRIEF DESCRIPTION OF THE DRAWINGS

The patent or application file and manuscript being filed herewith contains at least one drawing executed in color. Copies of this patent or patent application publication with color drawings will be provided by the Office upon request and payment of the necessary fec.

The foregoing will be apparent from the following more particular description of example embodiments, as illustrated in the drawings interspersed in the manuscript being filed herewith. The drawings are not necessarily to scale, emphasis instead being placed upon illustrating embodiments.

FIG. 1 is a flow diagram of a process of optimizing a neural network via semantic inference in one embodiment.

FIG. 2 is a diagram depicting filter activations of different inputs in one embodiment.

FIG. 3 is a diagram of a process of determining a Discriminative Capability Score (DCS) in one embodiment.

FIG. 4 is a diagram of a classification system in one embodiment.

FIG. 5 is a flow diagram of a process of classification in one embodiment.

### DETAILED DESCRIPTION

A description of example embodiments follows.

State of the art DNNs employ a large number of parameters. For example, YoLov10 uses a DNN backbone with 29.5 million parameters, which makes it hardly applicable in resource-constrained mobile systems such as unmanned autonomous vehicles (UAVs), which need to frequently perform object detection and semantic segmentation to avoid obstacles during navigation and build detailed 3D maps.

Previous work has been devoted to reduce the complexity of DNNs. Mobile-specific DNNs such as MobileNet and MnasNet reduce the computational load to the detriment of classification accuracy. For example, MobileNet loses up to 6.4% in accuracy compared to ResNet-152. Alternative approaches include pruning, quantization, and coding, which also incur in excessive DNN performance loss. Moreover, most pruning approaches requires fine-tuning, which is time-expensive. Another line of work designs dynamic DNNs, which can provide a trade-off between performance and resource consumption. A key issue with dynamic DNNs is to distinguish between easy-to-classify and hard-to-classify inputs. In stark contrast, we tackle this problem by introducing cluster-level dynamic DNNs. Specifically, prior work has shown that classes are easy or hard to classify based on their semantics. For example, animals are easier to be classified than bags, since they are larger and have brighter colors. As such, if we understood which portions of the DNN activate for “easy” semantic classes, we would avoid executing the entire DNN and only execute the much smaller portion related to that semantic class.

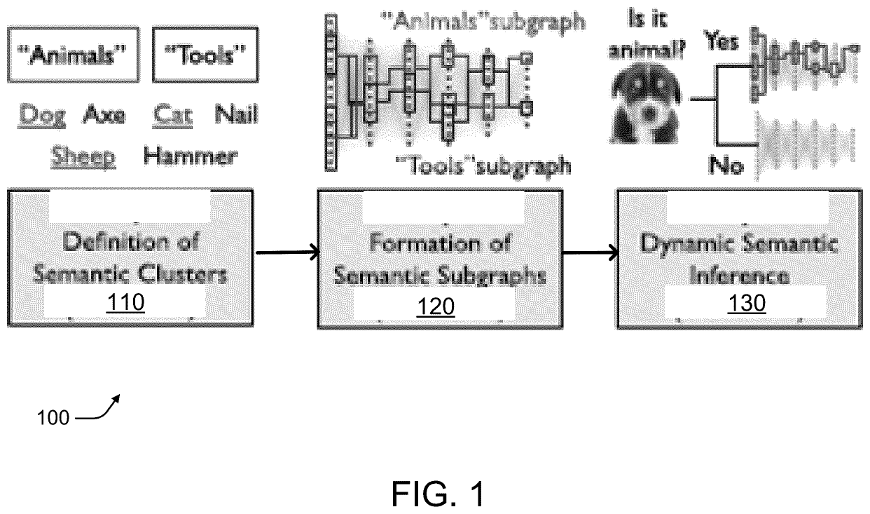

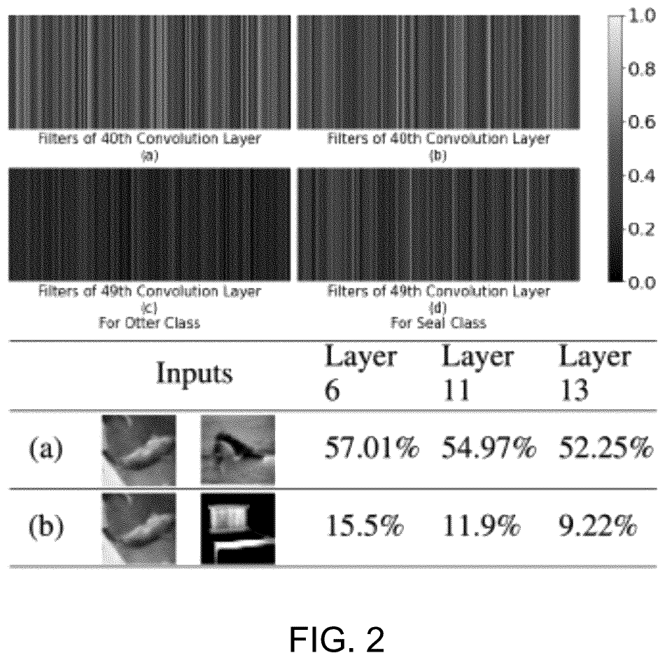

FIG. 1 is a flow diagram of a process of optimizing a neural network via semantic inference in one embodiment. Example embodiments provide an inference framework referred to as Semantic Inference (SINF). A key observation is that semantically similar inputs share a significant number of filter activations compared to semantically dissimilar inputs, especially in the earlier layers. For example, as shown in FIG. 2, images of seals share significantly more filter activations with images of dolphins than with images of tables. Based on these intuitions, SINF transforms a pre-trained and static DNN into a dynamic DNN by a) defining semantic clusters (110), b) creating subgraphs corresponding to each semantic cluster (120), and 3) selecting the semantic-relevant subgraphs at inference time based on a preliminary cluster-based assignment of the input image, also referred to as dynamic semantic inference (130).

In example embodiments the SINF inference framework can logically partition the DNN into subgraphs considering semantic similarities among different classes. To achieve this goal, a solution referred to as a Discriminative Capability Scoring (DCS) may be used to find the filters that can best distinguish semantically similar classes. SINF may pre-classify the image based on the cluster so that only the subgraph relevant to the input's semantic cluster gets activated. Conversely from existing work in pruning, SINF separates itself from pruning approaches as it does not perform fine-tuning. Instead, SINF executes sub-portions of an existing DNN.

Defining the concept of semantic cluster: Let D be a labeled dataset with class labels K. We define K semantic clusters, each composed by a subset of classes {γ₁, . . . , γ_{K}} such that γ₁ ∪γ₂∪ . . . γ_{K}=K. We primarily assume that these clusters are formed based on similarity of the semantics of their member classes. These semantics can be defined on an application-level. For example, different kinds of flowers show similar semantics, while flowers and animals show significantly different semantic characteristics. The clusters can also be pre-defined at the dataset level.

FIG. 2 is a diagram depicting filter activations of different inputs in one embodiment. The top portion of FIG. 2 shows We perform a series of experiments to validate the intuition behind the SINF approach. Filters of a DNN identify parts of objects, colors or concepts. Many of these filters are shared among classes. On the other hand, filter activations become sparser as the DNN becomes deeper, with filters reacting only to specific inputs belonging to specific classes. This phenomenon can be observed in the top portion of FIG. 2, which shows the average filter activation strength for the “otter” and “seal” classes in the 40th and 49th convolutional layers of a DNN (e.g., ResNet50 trained on CIFAR100).

This experiment reinforces the notion that filters in earlier layers are less specialized than filters in deeper layers. Moreover, it remarks that filters from semantically similar classes get similarly activated, especially in earlier layers. To put it in more quantitative terms, the Li distance of the activation maps of the mentioned classes in the 40th layer is 0.028, while the same for the 49th layer is 0.111. To further investigate this critical aspect, we have performed additional experiments where we have computed the percentage of filters “shared” among different classes for each layer of VGG16. Specifically, we have tagged each filter with the top 20 classes for which it gets activated. For each pair of classes, their similarity is calculated as the number of filters tagged with both classes over the number of filters tagged with at least one of the classes. The results are shown in the bottom portion of FIG. 2, where the first row shows the filters shared between the “dolphin” and “whale” classes-two semantically similar classes. The second row shows the filter sharing between two semantically dissimilar classes “dolphin” and “table.” As can be seen, the semantically similar classes share more filters.

In example embodiments, the subgraphs corresponding to each semantic cluster must be defined. We formalize this operation as Semantic DNN Subgraph Problem (SDSP). We consider a DNN F trained on dataset D as a computation graph, while the filters of the DNN work as the nodes of the graph. The SDSP may be defined as follows:

Find K proper subgraphs F_{γ} . . . F_{γ}, such that

$${B}_{eval} ( F , {D}_{γ} ) \leq {B}_{eval} ( {F}_{γ} , {D}_{γ} ) + ϵ , \qquad ( 1 )$$

where ϵ is an error margin and F_{γ}_{ᵢ}⊂F and D_{γ}_{ᵢ}⊂D are respectively the proper subgraphs of F and subset of data corresponding to the semantic cluster γᵢ. The function Bₑᵥₐₗ is the metric to measure performance of the DNN on the subsets of dataset corresponding to semantic clusters. A higher value of Bₑᵥₐₗ corresponds to better performance. Thus, the subgraph F_{γi} contains the nodes of F that best classifies the members of the semantic cluster γᵢ within error margin of ϵ. Although we chose the evaluation metric Bₑᵥₐₗ as accuracy, it can be set to any other performance metric according to the task.

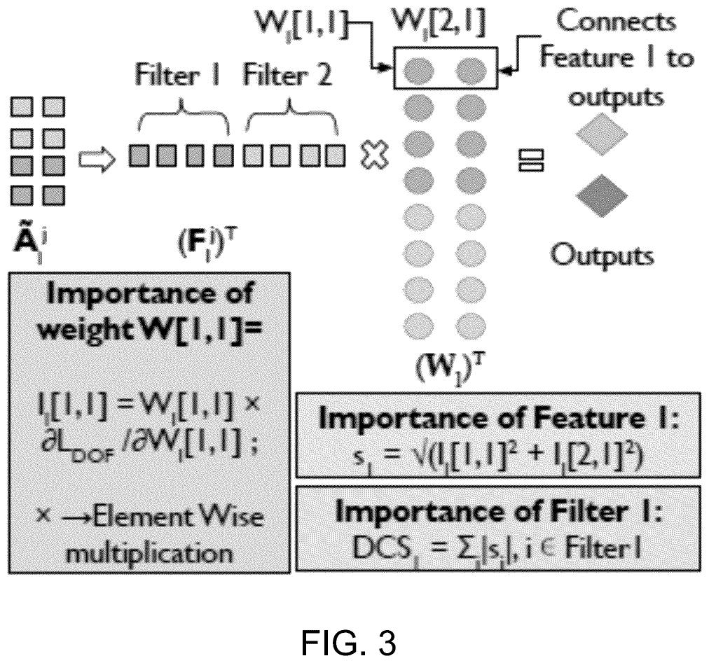

FIG. 3 is a diagram of a process of determining a Discriminative Capability Score (DCS) in one embodiment. The DCS aims to satisfy Eq. (1) above by extracting the filters from each layer of a DNN that best discriminate among the members of a semantic cluster γ. We start by considering the activation map

$${A}_{l}^{j} ∈ {ℝ}^{{C}_{out}^{l} \times k \times k}$$

Of a generic layer l of a DNN for input X^{j} (with target label t^{j})∈D_{γ}. Here, Cₒᵤₜ is the number of channels, and k is the size of a single channel of the activation map. The activation map may then be flattened to obtain feature map

$${F}_{l}^{j} ∈ {ℝ}^{{C}_{out}^{l} {k}^{′2}}$$

For the layer l and input Xj. One goal is to first learn a linear transformation

$${W}_{l} ∈ {ℝ}^{\vert γ \vert \times {C}_{out}^{l} {k}^{′2}}$$

(|γ=cardinality of set y) that can distinguish the members of y from the feature maps. We learn this transformation by minimizing the objective function L_{DOF}:

$${W}_{l}^{*} = {arg min}_{W} \frac{1}{\vert {𝒟}_{γ m} \vert} {\sum }_{j = 1}^{j = \vert {𝒟}_{γ m} \vert} {ℒ}_{DOF} ( {W}_{l} \cdot {F}_{l}^{j} , {t}^{j} ) , \qquad ( 2 )$$

Once the transformation Wₗ is learned, the importance of the features and, in turn, the filters, is encoded in Wₗ.

As shown in FIG. 3, the feature vector and the weight matrix in transposed form. Each column of the weight matrix Wₗ connects a single feature to the outputs. The weights of these connections can be used to directly measure the importance of the feature. The importance of the i-th feature in discriminating among the members of the cluster depend not only on the weight of its connections to the outputs but also on the sensitivity of those weights, i.e., the gradient of the objective function with respect of those weights. As a result, the importance of the i-th feature can be calculated as

$${s}_{i} = \sqrt{{\sum }_{j = 1}^{{C}_{out}^{l} {k}^{′2}} {I [ j , i ]}^{2}}$$

As k′² consecutive features come from the same filter, the DCS of i-th filter of l-th layer can be calculated as:

$${DCS}_{i}^{l} = \sqrt{{\sum }_{j} \vert {s}_{j} \vert} , j ∈ Filter i$$

where j denotes indices of the features that come from the i-th filter.

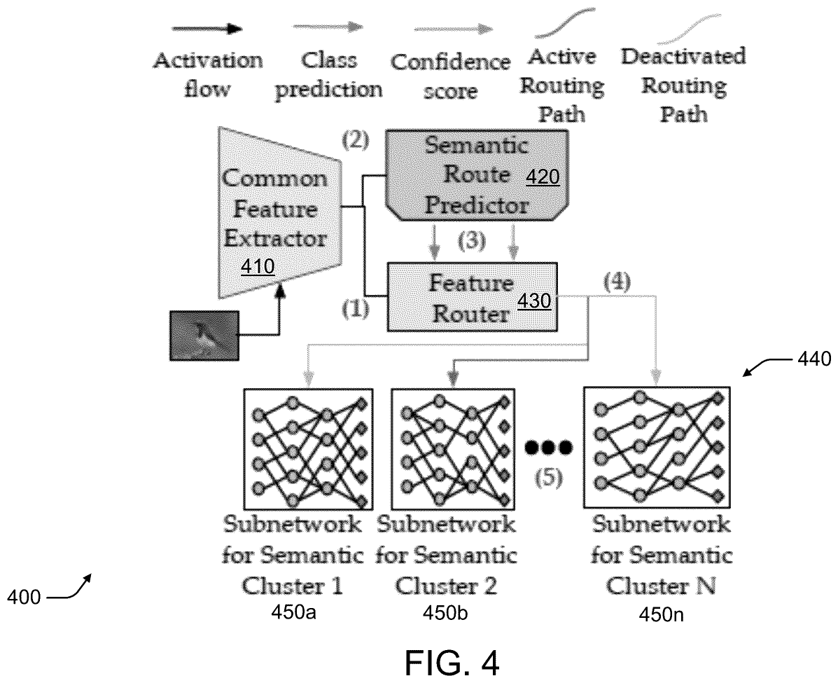

FIG. 4 is a diagram of a classification system 400 in one embodiment, which assigns each incoming input to a semantic cluster at runtime. The DNN may be divided into two portions: a Common Feature Extractor (CFE) 410 and the Semantic Subnetworks (SSN) 440 comprising subnetworks (subgraphs) 450a-n. The output of the CFE is used by a Semantic Route Predictor (SRP) 420 that classifies which semantic cluster the input belongs to. To this end, the features extracted by the CFE are passed to the SRP 420. The SRP 420 provides both the predicted semantic cluster and its confidence on its prediction to the Feature Router (FR) 430. Based on the SRP output, the features extracted by the CFE 410 are routed to the selected semantic subgraph (e.g., subgraph 450b) via the FR 430. Finally, the extracted subgraph provide the prediction. Although each subgraph is represented separately for clarity, in practice the separation may be only from a logical perspective. In other words, no additional memory beyond the annotations may be needed to characterize each subgraph used by the system 400. In some applications, particularly when performing classification on a resource-constrained device, a subset of the subgraphs 450a-n may be stored to the device for classification of the associated semantic clusters. Thus, a subset of the subgraphs may be stored to a memory independent of a remainder of the subgraphs.

Given a pretrained neural network, the first M−1 layers may be selected to act as the CFE. The output of the (M−1) the layer is fed into the SRP for coarse class prediction. This coarse class prediction is then utilized to select the subgraph to be activated from the rest of the network. Thus, the CFE 410 may be made from the layers of the DNN, while the SRP 420 may be external to the DNN, which is trained to provide coarse prediction.

The SRP 420 may be a classifier configured to predict the semantic clusters an input sample belongs to so that it can be forwarded towards the corresponding semantic subgraph. This may be done through an auxiliary classifier χ attached after the M−1-th layer of F. In the examples herein, M is chosen as the earliest layer providing classification accuracy of 75%. As such, the layers of F up to the M−1-th layer becomes the CFE. In one example, the architecture of the auxiliary classifier consists of two convolutional layers, followed by an adaptive average pooling layer stacked on top of three fully connected layers. We use the convolutional layers to tailor the activation map from layer l of base model F for classification of the semantic clusters. To train the auxiliary classifier χ, the first M−1 layers of F are frozen and the classifier is trained in supervised fashion using

$${\{ {A}_{M - 1}^{j} , {γ}_{m}^{j} \}}_{j = 1}^{j = \vert 𝒟 \vert}$$

as the dataset. Here, the first term is the activation layer activation of the M−1-th layer of the F, and the second term is the ground truth semantic cluster for the j-th sample. As we are considering a pre-trained base model, we train the auxiliary classifier separately from the base model using the activations obtained from the M−1-th layer. The output of the SRP is the probability distribution over the K different semantic clusters, and the input is assigned to the semantic cluster with the highest probability.

Further to above, the SRP may be trained in one example as follows:
a) The layers of the base DNN are frozen.
b) The training data is passed through the CFE and the feature map is subsequently fed into the SRP.
c) Using a SGD optimizer and cross-entropy loss, the SRP is trained independently.
d) For the configuration of the SRP, a number of convolution layers (e.g., 2) followed by a number of linear layers (e.g., 3) may be introduced.
e) While training the SRP in a supervised manner, the coarse class labels (corresponding to the semantic clusters) may be used.

Extraction of Subgraphs: L and M may be defined respectively as the last layer of the base model F and the layer after the CFE. We define rₗ as the percentage of retained filters in generic layer l. For semantic cluster γᵢ, we iterate from layer L to layer M to extract the subgraph. For each layer M≤l≤L, we calculate rₗ(r_{L}≤rₗ≥r_{M}), as well as the DCS score of the filters using DCS algorithm. The filters are ranked based on the DCS score and the indices of the top rₗ percent filters are saved. This is repeated for all the semantic clusters. If the average accuracy of the extracted subgraphs for the semantic clusters is above an accuracy threshold τ_{ace}, the indices of the filters belonging to the subgraphs are stored. This proce-dure is performed for different values of r_{L} and r_{M}.

Feature Router: The effectiveness of the DCS score and overall performance of SINF can be improved by conditioning the outputs of the SRP to the confidence of the SRP χ. The confidence score is a proxy for the probability that the predicted semantic cluster is correct. A higher confidence value represents higher probability that the SRP is able to correctly place the input in the proper semantic cluster. The Feature Router (FR) calculates this confidence by taking the activation map from χ along with the probability distribution from its prediction layer. To compute the confidence of the classifier on individual decisions, the FR employs a lightweight metric. The confidence score can be calculated as C_{χ}=Pₕ−Pₛₕ, using the highest (Pₕ) and the second highest probabilities (Pₛₕ) for individual semantic clusters. If the confidence score exceeds a threshold, the activation map is routed to the subgraph corresponding to the predicted semantic cluster. Otherwise the full base model F may be used for classification.

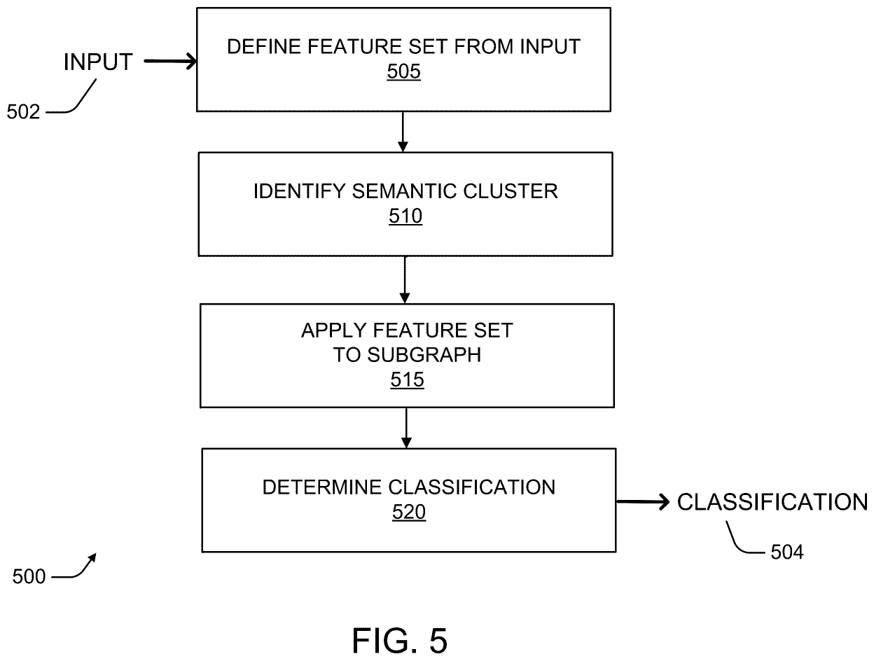

FIG. 5 is a flow diagram of a process 500 of classification in one embodiment. With reference to FIG. 4, upon receiving an input 502, a feature set may be defined from the input via the CFE 410 (505). A semantic cluster to be associated with the input may be defined based on the feature set (510) via the SRP 420, the semantic cluster being one of a plurality of semantic clusters each defining a subset of outputs of a neural network based on semantic similarity of the subset. The feature set may be applied to a subgraph (e.g., subgraph 450b) corresponding to the semantic cluster via the feature router 430, the subgraph being one of a plurality of subgraphs each defining a portion of the neural network (515). A classification 504 for the input 502 may then be determined based on an output of the subgraph 450b (515).

Nodes of the subgraph 450b may correspond to a subset of filters of the neural network, the subset of filters having an activation rate that exceeds a threshold value for members of the semantic cluster. The subgraph 450b may include at least one node common to another one of the plurality of subgraphs. The semantic cluster may be identified via at least one layer of the neural network. The subgraph 450b may encompass a set of filters of the neural network that are excluded by at least one of the plurality of subgraphs 450a-n.

Example embodiments as described above provide several advantages over previous classification methods, including greater classification speed while maintaining accuracy and being device-agnostic. Example embodiments have been tested and demonstrate 30% less inference time with less than 2% loss in accuracy and 70% fewer parameters than comparable prior-art methods. Further, without retraining, DCS can be used to prune up to 49.65% of parameters with only 0.899% accuracy loss. In contrast, prior-art approaches must retrain to maintain good performance. When considering per-cluster accuracy, example embodiments have performed 8% better than the original DNN.

Further, example embodiments can be applied to a pre-trained model without the need for additional retraining. This gives flexibility in deployment that is not observed in previous methods. Such embodiments provide improved inference time while maintaining accuracy. For applications where retraining is not an option, example embodiments are superior to previous methods by a large margin, achieving a negligible accuracy drop while removing a large number of parameters.

An example use case for an embodiment is in drone surveillance. Surveillance often requires few specific classes. Drones may lack the resource to run large and computationally-heavy neural networks. In that case, one can deploy the part of the network (i.e., subgraph(s)) that is pertinent to the task at hand, thereby reducing burden on the drone while increasing its efficiency as its inference time will be reduced. The same or a different embodiment can also or alternatively be used for deployment of a neural network in mobile devices in resource-constrained scenarios. Such an application allows faster inference and also smaller number of parameters at inference time. This saves both memory and energy.

A further application is in augmented reality (AR) and virtual reality (VR). Example embodiments can provide both faster inference and specialization for different tasks, and provide scope for split computation, which can add further advantage for heavy computational burden that is present in AR/VR domain. Commercial application of unmanned vehicles (e.g., drones, cars etc.) would be an additional application for such embodiments. Any other resource-constrained environment (e.g., mobile devices, IoT devices) with need of DNN deployment may benefit from application of example embodiments.

While example embodiments have been particularly shown and described, it will be understood by those skilled in the art that various changes in form and details may be made therein without departing from the scope of the embodiments encompassed by the appended claims.

What is claimed is:

1. A method of classification, comprising:
defining a feature set from an input;
identifying a semantic cluster to be associated with the input based on the feature set, the semantic cluster being one of a plurality of semantic clusters each defining a subset of outputs of a neural network based on semantic similarity of the subset;
applying the feature set to a subgraph corresponding to the semantic cluster, the subgraph being one of a plurality of subgraphs each defining a portion of the neural network; and
determining a classification for the input based on an output of the subgraph.

2. The method of claim 1, wherein nodes of the subgraph correspond to a subset of filters of the neural network, the subset of filters having an activation rate that exceeds a threshold value for members of the semantic cluster.

3. The method of claim 1, wherein nodes of the subgraph correspond to filters of the neural network, and wherein the subgraph includes at least one node common to another one of the plurality of subgraphs.

4. The method of claim 1, wherein the semantic cluster is identified via at least one layer of the neural network.

5. The method of claim 1, wherein the subgraph encompasses a set of filters of the neural network that are excluded by at least one of the plurality of subgraphs.

6. The method of claim 1, further comprising storing a subset of the subgraphs to a memory device independent of a remainder of the subgraphs.

7. A system for classification, comprising:
a feature extractor configured to define a feature set from an input;
a predictor configured to identify a semantic cluster to be associated with the input based on the feature set, the semantic cluster being one of a plurality of semantic clusters each defining a subset of outputs of a neural network based on semantic similarity of the subset;
a plurality of subgraphs each defining a portion of the neural network; and
a router configured to apply the feature set to a subgraph corresponding to the semantic cluster, the subgraph being one of a plurality of the plurality of subgraphs;
the subgraph being configured to generate an output for determining a classification for the input.

8. The system of claim 7, wherein nodes of the subgraph correspond to a subset of filters of the neural network, the subset of filters having an activation rate that exceeds a threshold value for members of the semantic cluster.

9. The system of claim 7, wherein nodes of the subgraph correspond to filters of the neural network, and wherein the subgraph includes at least one node common to another one of the plurality of subgraphs.

10. The system of claim 7, wherein the semantic cluster is identified via at least one layer of the neural network.

11. The system of claim 7, wherein the subgraph encompasses a set of filters of the neural network that are excluded by at least one of the plurality of subgraphs.

12. The system of claim 7, wherein a subset of the subgraphs are stored to a memory device independent of a remainder of the subgraphs.

13. A method of optimizing a neural network, comprising:
defining a plurality of semantic clusters for a dataset of inputs to the neural network, each of the semantic clusters including a subset of the inputs based on semantic similarity of the subset;
defining a plurality of subgraphs each corresponding to one of the semantic clusters, each of the subgraphs being a portion of the neural network; and
generating a router configured to 1) associate an input with one of the semantic clusters, and 2) apply the input to the associated semantic cluster.

14. The method of claim 13, wherein nodes of the subgraphs correspond to a subset of filters of the neural network, the subset of filters having an activation rate that exceeds a threshold value for members of the semantic cluster.

15. The method of claim 13, wherein nodes of the subgraph correspond to filters of the neural network, and wherein the subgraph includes at least one node common to another one of the plurality of subgraphs.

16. The method of claim 13, wherein the associated semantic cluster is identified via at least one layer of the neural network.

17. The method of claim 13, wherein each of the plurality of subgraph encompasses a set of filters of the neural network that are excluded by at least one of the plurality of subgraphs.

18. The method of claim 13, further comprising storing a subset of the subgraphs to a memory device independent of a remainder of the subgraphs.
